(19) United States
(12) Patent Application Publication
(10) Pub. No.: US 2025/0300530 A1
(43) Pub. Date: Sep. 25, 2025

(54) DEVICE AND METHOD FOR MANUFACTURING ROTOR FOR INDUCTION MOTOR

(71) Applicants: HYUNDAI MOTOR COMPANY, SEOUL (KR); KIA CORPORATION, SEOUL (KR); DR AXION CO., LTD., BUSAN (KR)

(72) Inventors: Myoung-Ho LEE, Hwaseong-si (KR); Sug-Won HEO, Hwaseong-si (KR); Kyoung-Yong KIM, Hwaseong-si (KR); Woo-Chun KIM, Busan (KR); Sang-Beom KIM, Yangsan-si (KR); Ja-Uk KOO, Yangsan-si (KR)

(73) Assignees: HYUNDAI MOTOR COMPANY, SEOUL (KR); KIA CORPORATION, SEOUL (KR); DR AXION CO., LTD., BUSAN (KR)

(21) Appl. No.: 18/679,690

(22) Filed: May 31, 2024

(30) Foreign Application Priority Data
Mar. 20, 2024 (KR) 10-2024-0038368

(51) Int. Cl. H02K 15/00; B23P 19/02

(52) U.S. Cl. CPC H02K 15/023; B23P 19/02

(57) ABSTRACT

A device for manufacturing a rotor for an induction motor includes an upper mold formed at a center of a bottom surface of a base portion, a lower mold formed in a center of an upper surface of the base portion, a sleeve formed on an inner surface of the lower mold, a biscuit which is formed inside the sleeve and into which a molten metal is injected, and a plunger disposed inside the sleeve, wherein the rotor assembly is pressurized in a vertical direction and an outer peripheral surface of a core of the rotor assembly is filled with the molten metal to manufacture a rotor. According to the present disclosure, it is possible to cast the rotor in a vertical manner and pressurize both ends of the rotor to achieve zero porosity and prevent contraction and deformation of the core.

### CROSS-REFERENCE(S) TO RELATED APPLICATIONS

This application claims priority to Korean Patent Application No. 10-2024-0038368, filed on Mar. 20, 2024, which is incorporated herein by reference in its entirety.

### BACKGROUND

### Field

Exemplary embodiments of the present disclosure relate to a device and method for manufacturing a rotor for an induction motor.

### Description of Related Art

An induction motor is a device that generates a rotational force by converting electrical energy into mechanical energy. An alternating-current (AC) motor basically includes an external stator and an internal rotor, and when an AC current is supplied to a stator winding, an electric field changes due to electromagnetic induction, an induced current is generated in the rotor, and a rotational force is generated based on a rotation axis due to a torque.

The rotor is formed by mainly using a method of filling and molding an aluminum molten metal into an electrical steel core by horizontally pressing the aluminum molten metal at high pressure. This method is widely used because a mold structure is simple and a production cost is low. However, in the case of the above-described method, casting defects are easily incorporated into the product due to limitations in the production method, and thus a decrease in motor efficiency occurs.

As shown in FIG. 1, in the case of horizontal die casting, since a rotor 1 is cast in horizontal type die casting device, bubble defects in the product are concentrated due to an influence of gravity. In the case of a rotor of the induction motor, since the rotor is a rotating body that operates at tens of thousands of revolution per minute (RPM), problems such as heat generation, noise, vibration, and efficiency degradation occur when defects in products are concentrated.

When the rotor is cast, contraction occurs after the aluminum molten metal solidifies, causing a problem of contraction and deformation of the electrical steel sheet. To solve this problem, a structure is needed to prevent deformation until the product completely solidifies.

The contents described in the above Description of Related Art are to aid understanding of the background of the present disclosure and may include what is not previously known to those skilled in the art to which the present disclosure pertains.

### SUMMARY

An embodiment of the present disclosure provides a method and device for manufacturing a rotor for an induction motor, which can achieve zero porosity in a product by casting the rotor in a vertical manner and pressurizing both ends of the rotor in a longitudinal direction and prevent contraction and deformation of a core after solidification of a molten metal.

Other objects and advantages of the present disclosure can be understood by the following description and become apparent with reference to the embodiments of the present disclosure. Also, it is obvious to those skilled in the art to which the present disclosure pertains that the objects and advantages of the present disclosure can be realized by the means as claimed and combinations thereof.

In accordance with an embodiment of the present disclosure, there is provided a device for manufacturing a rotor for an induction motor, which includes an upper mold in which a cavity mold into which a rotor assembly is inserted is configured at a center of a bottom surface of a base portion, a lower mold in which a cavity holder on which the rotor assembly is seated is configured in a center of an upper surface of the base portion, a sleeve configured on an inner surface of the lower mold below the cavity holder, a biscuit which is placed inside the sleeve and into which a molten metal is injected, and a plunger disposed inside the sleeve below the biscuit, wherein the rotor assembly is pressurized in a vertical direction and an outer peripheral surface of a core of the rotor assembly is filled with the molten metal in a longitudinal direction to manufacture a rotor.

In addition, the device may further include a plurality of squeeze pins configured to pass through the cavity mold to pressurize an upper surface of the core.

In addition, the device may further include a pair of slide cores disposed to face each other in a lateral direction based on the rotor assembly and configured to support a side surface of the rotor assembly.

Meanwhile, the rotor assembly may include a gate plate in which a plurality of gates are formed on a concentric circle, a jig shaft coupled to a center of the gate plate, and the core which is seated on the gate plate and which includes a hollow through which the jig shaft passes.

In addition, the rotor assembly may further include an end ring implementation jig mounted on the upper surface of the core.

In addition, the rotor assembly may further include a bolt engaged with a screw thread formed on the jig shaft.

Furthermore, a side surface of the gate may have an inclined shape to allow a diameter of an upper surface to be greater than a diameter of a lower surface, and an inclination angle may be in the range of 5°±1°.

In addition, a diameter of the upper surface of the gate may range from 9.5 mm to 11.5 mm, a height of the gate may range from 10 mm to 15 mm, and the number of gates may range from 12 to 18.

In accordance with another embodiment of the present disclosure, there is provided a method of manufacturing a rotor for an induction motor using the device for manufacturing a rotor for an induction motor, which includes preparing the rotor assembly, opening the upper mold and the lower mold and injecting a molten metal into the biscuit, seating the rotor assembly inside the cavity holder and on the sleeve, moving down the upper mold to be combined with the lower mold, and pressurizing the rotor assembly by integrally moving down the upper mold and the lower mold, and additionally pressurizing the rotor assembly by moving up the plunger in a state in which the molten metal fills by the pressurizing of the rotor assembly.

Here, the molten metal may be aluminum, and the method may further include preheating the core of the rotor assembly at a temperature ranging from 300° C. to 500° C. before the seating of the rotor assembly on the sleeve.

In addition, the method may further include, in a state in which the molten metal fills by the pressurizing of the rotor assembly, pressurizing the rotor assembly by moving down the plurality of squeeze pins which pass through the cavity mold and press the upper surface of the core.

In addition, the pressurizing of the rotor assembly may further include supporting a side surface of the rotor assembly by operating a pair of slide cores disposed to face each other in a lateral direction based on the rotor assembly.

Meanwhile, the preparing of the rotor assembly may include coupling a jig shaft to a center of a gate plate on which a plurality of gates are formed on a concentric circle, and seating the core on the gate plate by passing the jig shaft through a hollow of the core.

In addition, the preparing of the rotor assembly may further include seating an end ring implementation jig on the upper surface of the core.

In addition, the preparing of the rotor assembly may further include engaging a bolt to a screw thread formed on the jig shaft.

### BRIEF DESCRIPTION OF THE DRAWINGS

FIG. 1 is a diagram illustrating a quality problem of a rotor manufactured by a conventional method.

FIG. 2 is a diagram illustrating a device for manufacturing a rotor for an induction motor of the present disclosure.

FIG. 3 is a diagram illustrating a shape of a bottom surface of an upper mold of the device for manufacturing a rotor for an induction motor of the present disclosure.

FIG. 4 is a diagram illustrating a shape of a portion of FIG. 3.

FIG. 5 is a diagram illustrating a shape of a top surface of a lower mold of the device for manufacturing a rotor for an induction motor of the present disclosure.

FIG. 6 is a diagram illustrating a cross-sectional shape of the device for manufacturing a rotor for an induction motor of the present disclosure.

FIGS. 7, 8, 9, 10, 11, 12, 13, and 14 are diagrams illustrating sequentially a manufacturing process of the device for manufacturing a rotor for an induction motor of the present disclosure.

FIGS. 15, 16, 17, and 18 are diagrams illustrating separately some of the manufacturing process of the device for manufacturing a rotor for an induction motor of the present disclosure.

FIG. 19 is a diagram illustrating a rotor assembly of the present disclosure, and

FIG. 20 is a diagram illustrating shapes of bottom surfaces of some of components of the rotor assembly.

FIGS. 21, 22, 23, 24, a5, and 26 are diagrams illustrating sequentially a preparation process of the rotor assembly of the present disclosure.

FIG. 27 is a diagram illustrating a state in which the rotor assembly of the present disclosure is inserted into the device for manufacturing a rotor for an induction motor.

FIG. 28 is a diagram illustrating a shape of a gate.

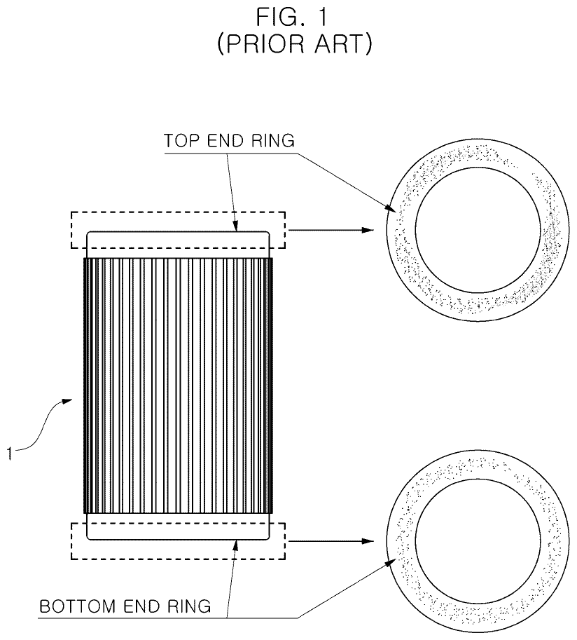

### DETAILED DESCRIPTION

In order to fully understand the present disclosure and operational advantages of the present disclosure and objects attained by practicing the present disclosure, reference should be made to the accompanying drawings that illustrate exemplary embodiments of the present disclosure and to the description in the accompanying drawings.

In describing exemplary embodiments of the present disclosure, known technologies or repeated descriptions may be reduced or omitted to avoid unnecessarily obscuring the gist of the present disclosure.

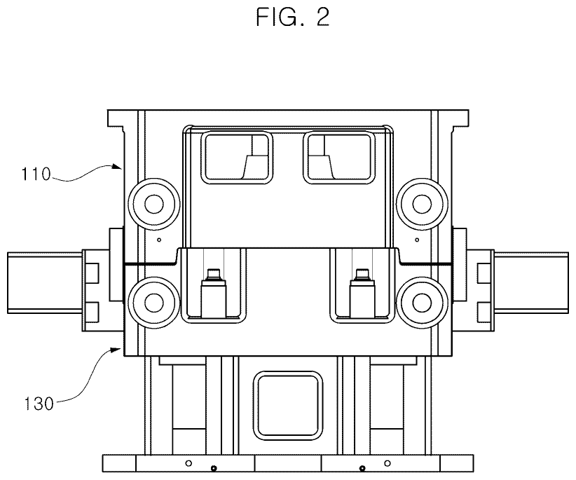

FIG. 2 is a diagram illustrating a device for manufacturing a rotor for an induction motor of the present disclosure.

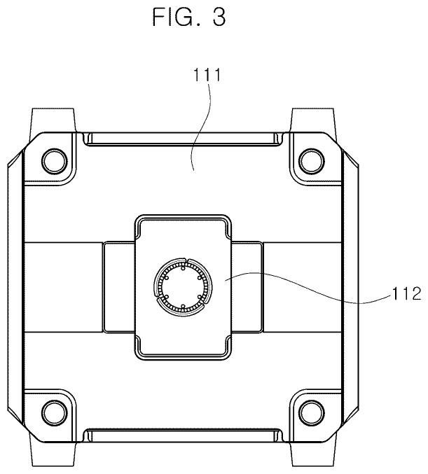

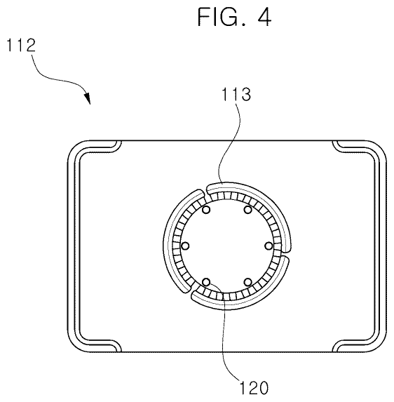

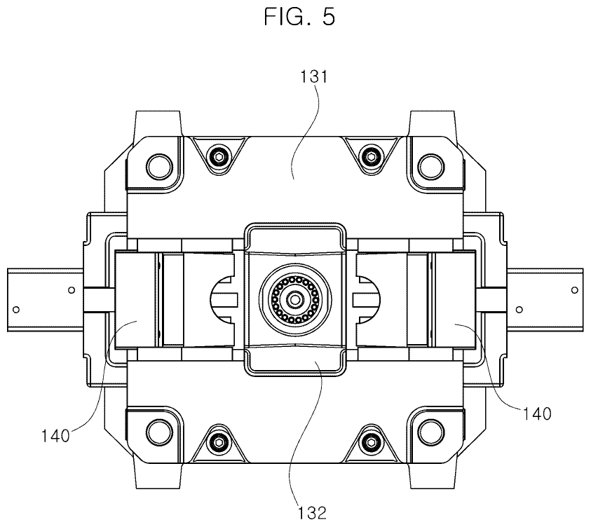

In addition, FIG. 3 is a diagram illustrating a shape of a bottom surface of an upper mold of the device for manufacturing a rotor for an induction motor of the present disclosure, FIG. 4 is a diagram illustrating a shape of a portion of FIG. 3, and FIG. 5 is a diagram illustrating a shape of a top surface of a lower mold of the device for manufacturing a rotor for an induction motor of the present disclosure.

Hereinafter, a method and device for manufacturing a rotor for an induction motor according to one embodiment of the present disclosure will be described with reference to FIGS. 2 to 5.

According to the present disclosure, a rotor for an induction motor, which is manufactured by casting an aluminum molten metal on an electrical steel sheet core, is manufactured in a vertical pressing manner instead of the existing horizontal pressing manner, thereby achieving zero porosity in a product and preventing contraction and deformation of a core after the aluminum molten metal solidifies.

To this end, the device for manufacturing a rotor for an induction motor includes an upper mold 110, a lower mold 130, a slide core 140, and a plunger 150, a rotor assembly 200, which will be described below, is inserted a cavity formed between the upper mold 110 and the lower mold 130, and a molten metal is injected into an outer circumferential surface of a core in a longitudinal direction to cast the rotor.

In the upper mold 110, a cavity mold 112 is configured in the center of a bottom surface of a base portion 111.

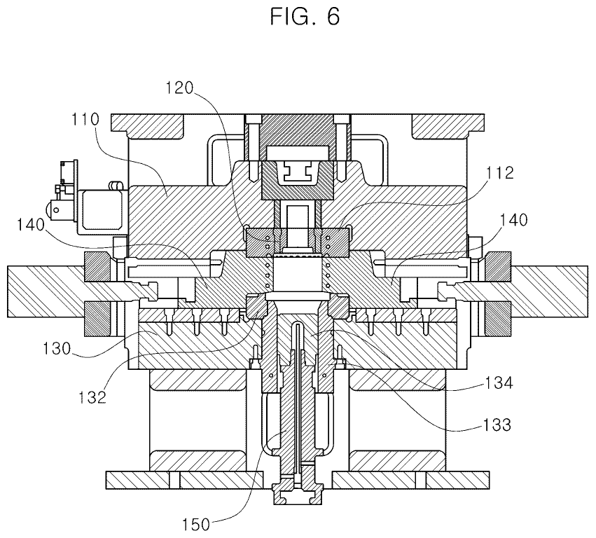

As shown in FIG. 6, the cavity mold 112 is a mold formed to allow an upper portion of the rotor assembly 200 to be inserted into and to pass through the cavity mold 112, and a squeeze hole through which a plurality of squeeze pins 120 pass is formed through the cavity mold 112. During casting, the squeeze pin 120 pressurizes an upper surface of the rotor.

An overflow portion 113 is formed as a space for an overflow molten metal in an outer side of the squeeze hole,

In the lower mold 130, a cavity holder 132 on which the rotor assembly 200, which will be described below, is seated is configured in the center of an upper surface of the base portion 131.

In addition, a sleeve 133 is configured on an inner surface of the lower mold 130 below the cavity holder 132.

A plunger 150 for injecting a molten metal is disposed inside the sleeve 133 and below the cavity holder 132, and a tip 134 is formed at a fore-end of the plunger 150.

In addition, a pair of slide cores 140 are disposed to face in a lateral direction based on the rotor assembly 200 to support a side surface of the rotor assembly 200.

Operating parts for operating the upper mold 110, the lower mold 130, the squeeze pin 120, the slide core 140, and the plunger 150, which are described, and control parts for controlling them may also be included.

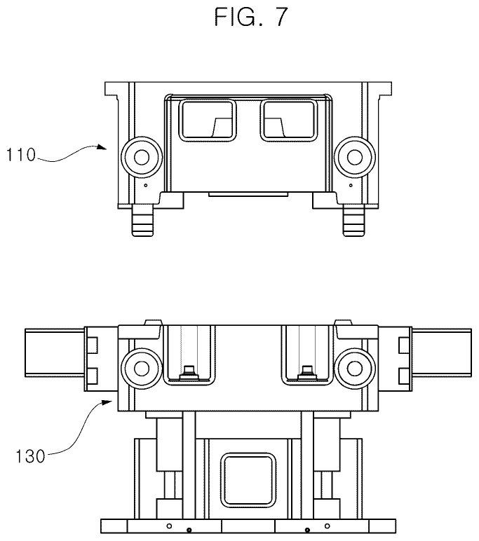

FIGS. 7 to 14 are diagrams illustrating sequentially a manufacturing process of the device for manufacturing a rotor for an induction motor of the present disclosure.

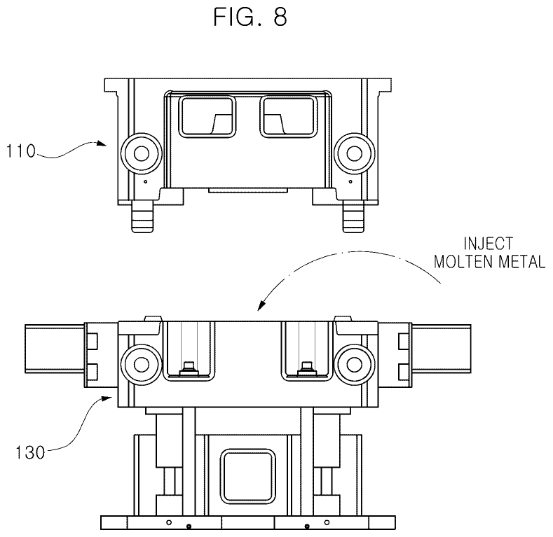

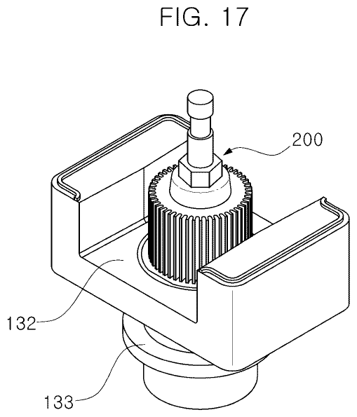

According to the method of manufacturing a rotor for an induction motor of the present disclosure, the upper mold 110 and the lower mold 130 are opened as shown in FIG. 7, and then a molten metal m is injected into a biscuit 137 placed inside the sleeve 133 as shown in FIGS. 8 and 16.

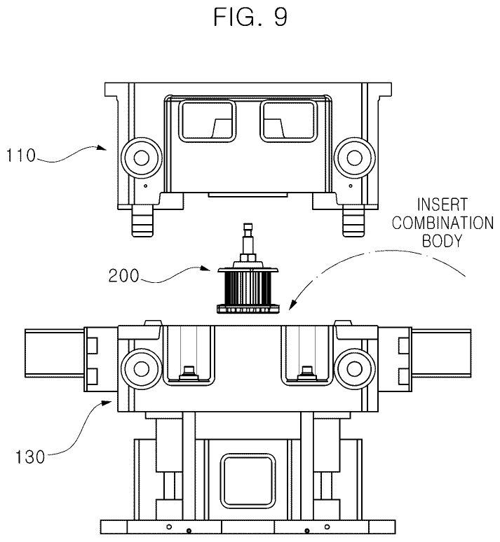

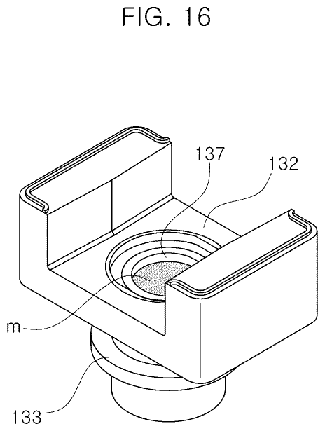

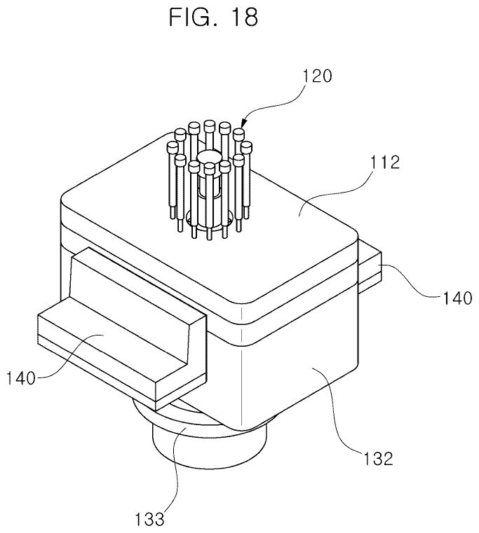

After the molten metal is injected, as shown in FIG. 9, the prepared rotor assembly 200 is seated inside the cavity holder 132 and on the sleeve 133. A seating surface can be seen in FIG. 15, the seated state is shown in FIG. 17, and the core may be preheated.

A temperature of the molten metal ranges from 750° C. to 850° C., and when a preheating temperature of the core ranges from 300° C. to 500° C., and an aluminum filling rate is most desirable. When a temperature is less than 300° C., slot defects may occur.

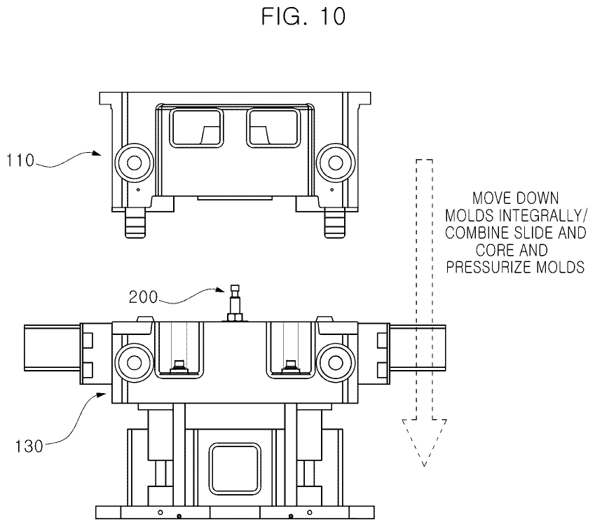

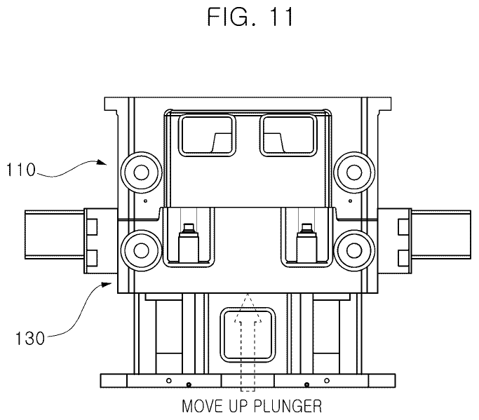

Next, as shown in FIG. 10, the upper mold 110 and the lower mold 130 are combined, and the slide core 140 is moved forward and combined by a slide core operating part to support the side surface of the rotor assembly 200. After the upper mold 110 is moved down to be combined with the lower mold 130, the upper mold 110 and the lower mold 130 are moved down together to fill an outer peripheral surface of the core with the molten metal in the length direction through the gate 136 and to pressurize the rotor assembly 200.

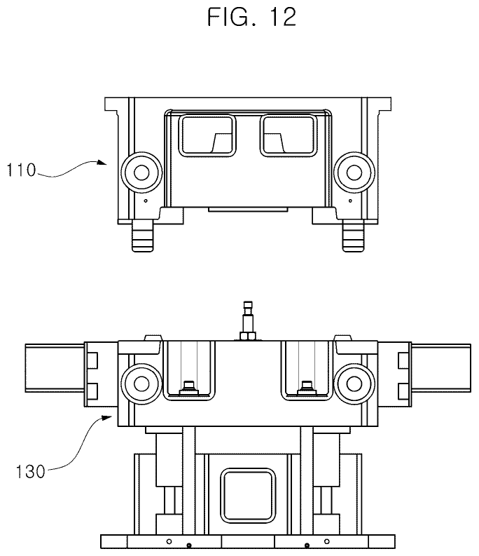

In a state in which the molten metal is filled at 100% by pressurizing the rotor assembly 200, as shown in FIG. 11, the plunger 150 below the tip 134 is moved up to perform second pressurization through the tip 134.

That is, in order to control internal contraction pores and minimize product defects that occur when the product solidifies after filling the molten metal through the mold movement, a pressure is increased to 700 Kgf/cm² to 1200 Kgf/cm² through the tip 134. In addition, as shown in FIG. 18, the squeeze pin 120 is moved down to pressurize a cast product.

In this way, by supplying the molten metal inside the mold through the mold movement, product defects can be minimized by reducing oxygen and hydrogen saturation in the molten metal due to minimization of molten metal movement through laminar flow filling.

In addition, product defects can be reduced by supplying an additional molten metal to a position where there is a shortage of a molten metal occurring during solidification through a pressure increase (move up the tip)+squeezing (move down the squeeze pin of the upper mold) during solidification after the aluminum filling.

Meanwhile, a casting cycle time can be shortened by differentiating a molten metal injection position from a core seating position.

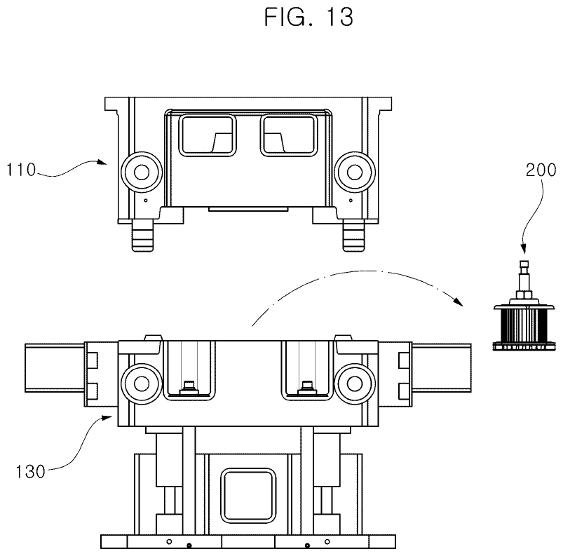

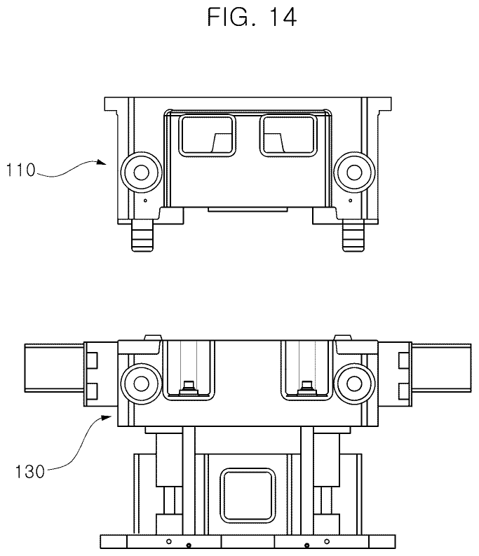

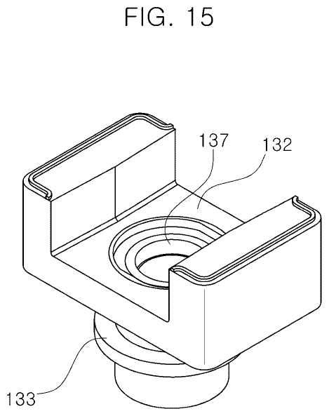

In this way, after completion of the casting, the upper mold 110, lower mold 130, and slide core 140 are opened as shown in FIG. 12, the cast rotor assembly 200 is unloaded as shown in FIG. 13, and as shown in FIG. 14, air and a release agent are applied inside the mold for a next process.

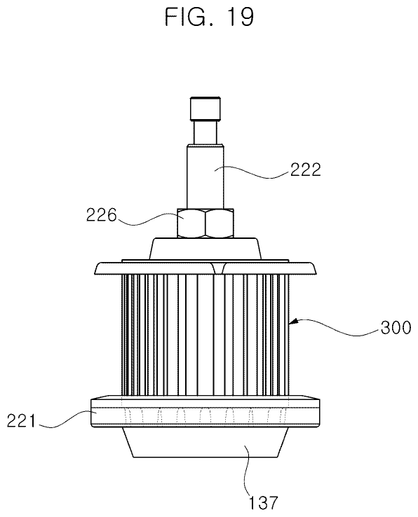

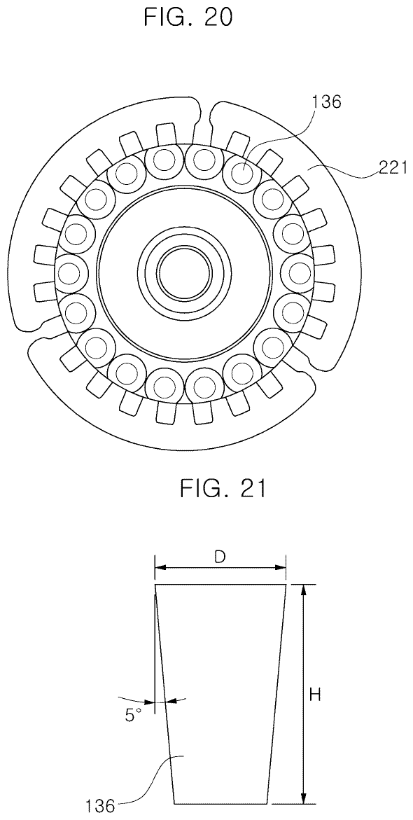

Next, FIG. 19 is a diagram illustrating a rotor assembly of the present disclosure, and FIG. 20 is a diagram illustrating shapes of bottom surfaces of some of components of the rotor assembly.

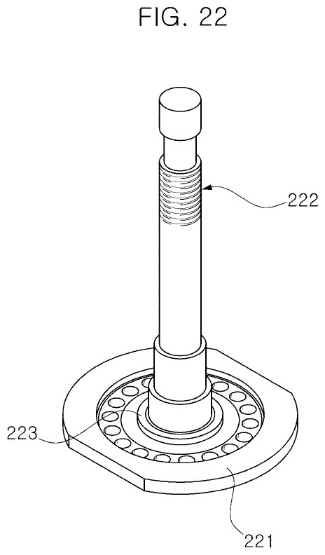

In addition, FIGS. 21 to 26 are diagrams illustrating sequentially a preparation process of the rotor assembly of the present disclosure.

The rotor assembly 200 is a combination body including a core 210. To sequentially describe components coupled to the core 210, as shown in FIG. 21, first, a jig shaft 222 is coupled to the center of a gate plate 221 in which a plurality of gates 136 are formed on a concentric circle. As shown in FIG. 20, the molten metal from the biscuit 137 is filled through the gate 136 formed on the gate plate 221, and the gate 136 is formed at a position corresponding to a casting portion of the rotor.

An asbestos gasket 223 is mounted on the gate plate 221 around the jig shaft 222, and as shown in FIG. 22, the core 210 is seated on the gate plate 221 to allow the jig shaft 222 to pass through a hollow of the core 210.

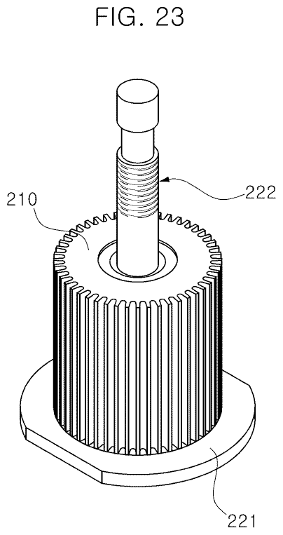

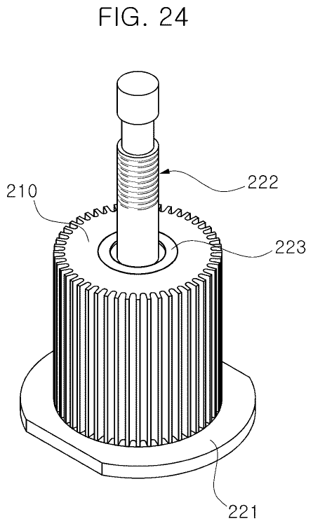

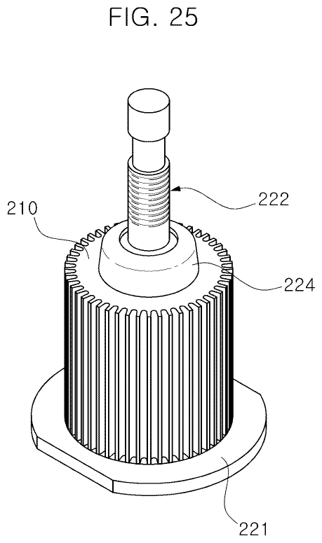

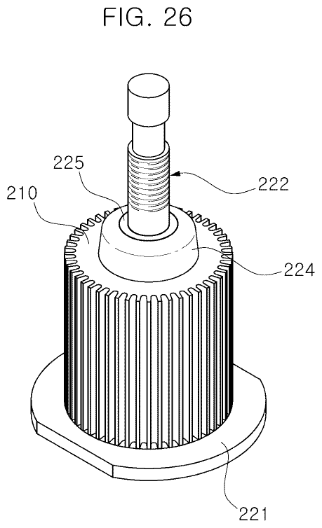

As shown in FIG. 23, the asbestos gasket 223 is mounted on a step formed at an upper end of the hollow of the core 210, and as shown in FIG. 24, an end ring implementation jig 224 is seated on an upper surface of core 210.

A washer 225 is seated on the end ring implementation jig 224, and a bolt 226 is coupled to the jig shaft 222 on which a screw thread is formed.

In a general casting method, an aluminum contracts during casting so that deformation of the electrical steel sheet may occur. However, according to the present disclosure, by using the rotor assembly 200, the rotor assembly 200 is used as a vertical pressure casting jig for preventing deformation of the electrical steel sheet and moving a product, and since the heated jig prevents core heat loss, there is an effect of delaying a temperature decrease of the molten metal.

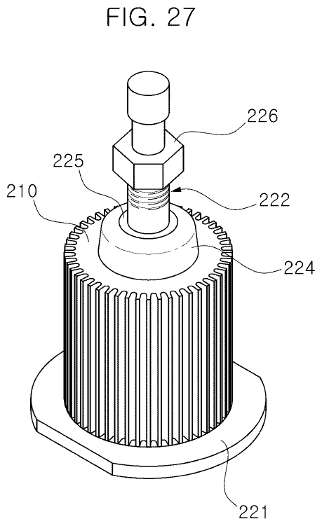

The rotor assembly 200 is seated on the cavity holder 132 to be cast, and as shown in FIG. 27, a rotor 300 is cast by the molten metal m injected through the gate 136, and a lower end ring 310 is formed on a bottom surface of the rotor 300.

After the inside of the core is filled with the aluminum through the descending of the combined molds, a problem of insufficient molten metal filling in the contraction and solidification portion of the lower end ring may occur due to entry into the line solid-liquid coexistence section of the gate. In the present disclosure, a contraction problem can be solved by moving the aluminum molten metal from the gate 136 to the lower end ring 310 through tip movement (pressure increase).

In addition, since the pressurization from a lower portion cannot be transmitted to an upper end ring, and the upper and lower end rings are connected by the slot, disconnection of the molten metal may occur during solidification. That is, since the molten metal passing through the lower end ring 310 should pass through a narrow slot to fill the upper end ring, disconnection can be solved by inserting the squeeze pin 120 into the upper portion to induce a similar effect to the lower plunger 150.

According to the method of the present disclosure, the filling rate of the upper and lower end rings of the rotor may reach a level of 99% or more.

Meanwhile, according to a gate shape, changes in filling rate and contraction behavior within a cage may occur due to molten metal movement.

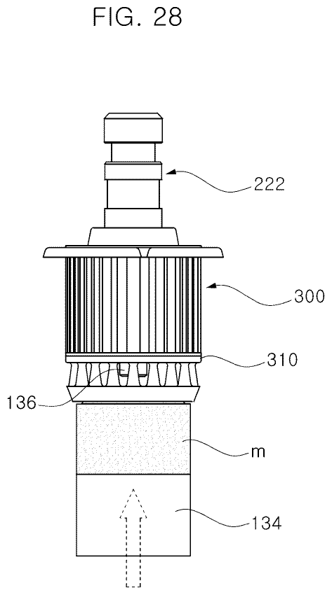

As an analysis result for optimal implementation of the gate shape, as shown in FIG. 28, it can be seen that the gate 136 preferably has a shape with an inclined side surface to allow an upper diameter is greater than a lower diameter, and an optimal inclination angle is in the range of 5°±1°.

In addition, as an evaluation result of an influence of a diameter D, a height H, and the number of gates of the upper surface, optimal results were obtained for an solidification influence when the diameter was 11.5 mm, the height was 15 mm, and the number of gates was 18 and for a filling influence when the diameter was 9.5 mm, the height was 10 mm, and the number of gates was 12. Therefore, by considering the above, it can be seen that the diameter of the gate 136 is desirable to be in the range of 9.5 mm to 11.5 mm, the height thereof is desirable to be in the range of 10 mm to 15 mm, and the number thereof is desirable to be in the range of 12 to 18.

A rotor for an induction motor manufactured by the manufacturing method of the present disclosure can implement zero porosity.

After a mold for molten metal filling is moved, second pressurization is applied using a plunger tip so as to improve internal quality so that product quality improvement is excellent.

In addition, by maintaining an inside of a mold in a vacuum state, the filling of a molten metal can be improved and mixing of air bubbles can be prevented.

In addition, by applying a product deformation prevention jig, deformation of electrical steel sheets can be suppressed and a core temperature can be maintained so that a temperature decrease of an aluminum molten metal can be prevented.

In addition, when casting is performed using a molten metal forging method, internal quality can be improved compared to the existing method and motor efficiency can be improved. When a casting defect occurs inside a rotor, motor efficiency decrease and heat generation problems occur due to increased resistance. However, this problem can be solved by the manufacturing method of the present disclosure.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A device for manufacturing a rotor for an induction motor, the device comprising:
an upper mold having a cavity mold into which a rotor assembly is inserted positioned at a center of a bottom surface of a base portion;
a lower mold having a cavity holder on which the rotor assembly is seated positioned in a center of an upper surface of the base portion;
a sleeve positioned on an inner surface of the lower mold below the cavity holder;
a biscuit positioned inside the sleeve and into which a molten metal is injected; and
a plunger positioned inside the sleeve below the biscuit,
wherein the rotor assembly is pressurized in a vertical direction, and an outer peripheral surface of a core of the rotor assembly is filled with the molten metal in a longitudinal direction to manufacture a rotor.

2. The device of claim 1, further comprising:
a plurality of squeeze pins configured to pass through the cavity mold to pressurize an upper surface of the core.

3. The device of claim 1, further comprising:
a pair of slide cores disposed to face each other in a lateral direction based on the rotor assembly, and configured to support a side surface of the rotor assembly.

4. The device of claim 1, wherein the rotor assembly includes:
a gate plate in which a plurality of gates are formed on a concentric circle;
a jig shaft coupled to a center of the gate plate; and
wherein the core is seated on the gate plate and includes a hollow through which the jig shaft passes.

5. The device of claim 4, wherein the rotor assembly further includes an end ring implementation jig mounted on the upper surface of the core.

6. The device of claim 4, wherein the rotor assembly further includes a bolt engaged with a screw thread formed on the jig shaft.

7. The device of claim 4, wherein a side surface of each of the plurality of gates has an inclined shape to allow a diameter of an upper surface to be greater than a diameter of a lower surface, and an inclination angle in a range of 5°±1°.

8. The device of claim 4, wherein a diameter of the upper surface of each of the plurality of gates ranges from 9.5 mm to 11.5 mm, a height of each of the plurality of gates ranges from 10 mm to 15 mm, and a number of the plurality of gates ranges from 12 to 18.

9. A method of manufacturing a rotor for an induction motor using the device for manufacturing a rotor for an induction motor of claim 1, the method comprising:
preparing the rotor assembly;
opening the upper mold and the lower mold and injecting a molten metal into the biscuit;
seating the rotor assembly inside the cavity holder and on the sleeve;
moving down the upper mold to be combined with the lower mold, and pressurizing the rotor assembly by integrally moving down the upper mold and the lower mold; and
additionally pressurizing the rotor assembly by moving up the plunger when the molten metal fills by the pressurizing of the rotor assembly.

10. The method of claim 9, wherein the molten metal is aluminum, and the method further includes preheating the core of the rotor assembly at a temperature ranging from 300° C. to 500° C. before the seating of the rotor assembly on the sleeve.

11. The method of claim 9, further comprising:
when the molten metal fills by the pressurizing of the rotor assembly, pressurizing the rotor assembly by moving down the plurality of squeeze pins which pass through the cavity mold and press the upper surface of the core.

12. The method of claim 9, wherein the pressurizing of the rotor assembly further includes supporting a side surface of the rotor assembly by moving a pair of slide cores disposed to face each other in a lateral direction based on the rotor assembly.

13. The method of claim 9, wherein the preparing of the rotor assembly includes:
coupling a jig shaft to a center of a gate plate on which a plurality of gates are formed on a concentric circle; and
seating the core on the gate plate by passing the jig shaft through a hollow of the core.

14. The method of claim 13, wherein the preparing of the rotor assembly further includes seating an end ring implementation jig on the upper surface of the core.

15. The method of claim 13, wherein the preparing of the rotor assembly further includes engaging a bolt to a screw thread formed on the jig shaft.
